(19) United States
(12) Patent Application Publication
(10) Pub. No.: US 2011/0211540 A1
(43) Pub. Date: Sep. 1, 2011

(54) METHOD AND APPARATUS FOR PROVIDING A COMMON DISPLAY OF CANDIDATE CONNECTIONS

(75) Inventors: Vappu Anna Leena Leinonen, Tampere (FI); Klaus Kenneth Gustav Anderson, Pirkkala (FI)

(73) Assignee: Nokia Corporation

(21) Appl. No.: 12/713,848

(22) Filed: Feb. 26, 2010

(51) Int. Cl. H04W 4/00

(52) U.S. Cl. 370/329

(57) ABSTRACT

A method, apparatus and computer program product are provided in order to provide a common display of a plurality of candidate connections to a wide area network, such as the Internet. A plurality of candidate connections to the wide area network are initially identified and a common display of the candidate connections is then presented. The candidate connections may be separated into at least two groups, with a first group including any candidate connection that is configured to be automatically established and a second group including any candidate connection that is not configured to be automatically established. A respective candidate connection may be switched between the first and second groups based upon user input directing the respective candidate connection to be included in a different group. By switching the respective candidate connection to be in the other group, the manner of establishing the respective candidate connection is correspondingly altered

### TECHNOLOGICAL FIELD

Embodiments of the present invention relate generally to a method and apparatus for providing information regarding a plurality of candidate connections to a wide area network and, more particularly, to a method and apparatus for providing a common display of the plurality of candidate connections to a wide area network.

### BACKGROUND

Users frequently utilize their mobile devices to establish connections to a wide area network, such as the Internet. For example, users may establish an Internet connection in order to retrieve information from a website, exchange email or other messages, transfer media files, place a voice over Internet Protocol (VoIP) call or the like. Although currently significant, the reliance upon mobile devices to provide connections to the Internet or other wide area networks continues to increase and promises to become an even more prevalent aspect of society.

Mobile devices may connect to a wide area network, such as the Internet, in a variety of different manners. For example, a mobile device may connect to a wireless local area network (WLAN) in order to access the Internet. Indeed, a mobile device may be able to connect to the Internet via any one of a plurality of WLANs with which the mobile device may communicate. Alternatively, a mobile device may establish connections to the Internet via a general packet radio service (GPRS) that supports packet data transmission.

Each different type of connection may be accessed differently and, as such, may require a different access procedure and/or credentials. For example, some Internet connections may be automatically established by a mobile device, while other Internet connections may require manual input for their establishment. In addition, some Internet connections, such as some of the Internet connections that require manual input for their establishment, may require the entry of one or more security credentials, such as a user name, a password, or the like. The different mechanisms utilized by a mobile device to access the Internet via the different connections may be confusing to the user or may otherwise not be as intuitive to the user as desired. In addition, it may sometimes be difficult to determine all of the Internet connections that are available to the mobile device, as well as the settings, parameters and/or credentials associated with each of the connection possibilities.

In regard to at least some of the Internet connections, a user is required to enter various credentials or other security information prior to being granted access to the network via the respective connection. In this regard, an installation or access wizard may be utilized to present the user with a series of display screens soliciting various information that is necessary in order to establish the desired connection. As the installation or access wizards typically present a plurality of display screens in sequence with each display screen soliciting different information, a user may become disinterested in the process as a result of the number of display screens that must be populated by the user prior to being granted access. Alternatively, a user may simply be confused by the series of display screens and believe that duplicative or unnecessary information is being collected prior to being granted access to the Internet via the desired connection.

### BRIEF SUMMARY

A method, apparatus and computer program product are thereby provided in order to provide a common display of a plurality of candidate connections to a wide area network, such as the Internet. By providing a common display, the user may quickly review the different connections that are available and, in one embodiment, may also determine parameters or other information associated with each candidate connection, such as whether the candidate connections may be either automatically established or require manual input. Thus, a user may be more fully apprised of the connections via which the mobile device may be connected to a wide area network, such as the Internet, so as to facilitate the selection of an appropriate connection.

A method is provided in accordance with one embodiment of the present invention that includes identifying a plurality of candidate connections to a wide area network and causing a common display of the candidate connections. In this regard, the candidate connections may be separated into at least two groups, with a first group including any candidate connection that is configured to be automatically established and a second group including any candidate connection that is not configured to be automatically established. The method of this embodiment may also switch a respective candidate connection between the first and second groups based upon user input directing the respective candidate connection to be included in a different group. As a result of switching the respective candidate connection to be in the other group, the manner of establishing the respective candidate connection is correspondingly altered.

An apparatus is provided in accordance with another embodiment that includes at least one processor and at least one memory including computer program code. The at least one memory and the computer program code are configured to, with the processor, cause the apparatus to identify a plurality of candidate connections to a wide area network and to cause a common display of the candidate connections. In this regard, causing the common display may include separating the candidate connections into at least two groups, with a first group including any candidate connection that is configured to be automatically established and a second group including any candidate connection that is not configured to be automatically established. The at least one memory and the computer program code may also be configured to, with the processor, cause the apparatus to switch a respective candidate connection between the first and second groups based upon user input directing that a respective candidate connection be included in a different group so that the manner of establishing the respective candidate connection is correspondingly altered.

In a further embodiment, a computer program product including at least one computer-readable storage medium having computer-executable program code portions stored therein, is provided with the computer-executable program code portions including program code instructions for identifying a plurality of candidate connections to a wide area network and program code instructions for causing a common display of the candidate connections. In this regard, the program code instructions for causing the common display may include program code instructions for separating the candidate connections into at least two groups, with a first group including any candidate connection that is configured to be automatically established and the second group including any candidate connection that is not configured to be automatically established. The computer-executable program code portions may also include program code instructions for switching a respective candidate connection between the first and second groups based upon user input directing that a respective candidate connection be included in a different group so that the manner of establishing the respective candidate connection is correspondingly altered.

In the foregoing embodiments, the separation of the candidate connections into at least two groups may include placing each candidate connection that has been previously utilized and that is configured to be automatically established in the first group. In this regard, the second group may be populated by each candidate connection that has been previously utilized but that is not configured to be automatically established as well as each candidate connection that is identified but that has not been previously utilized. In order to appropriately separate the candidate connections into the at least two groups, the identification of the plurality of candidate connections may include the receipt of an indication of each candidate connection identified in a scan and the identification, for each candidate connection, as to whether the respective candidate connection has been previously utilized and, in an instance in which the respective candidate connection has been previously utilized, whether the respective candidate connection is configured to be automatically established.

In regard to switching the respective candidate connections between groups, user input may be received that directs a candidate connection in the first group be moved to the second group such that a respective candidate connection is then configured to be manually established and/or that directs a candidate connection in the second group be moved to the first group such that a respective candidate connection is then configured to be automatically established. In one embodiment, the common display may also include the association of one or more icons with a candidate connection indicating the type of connection, whether the connection is secured and/or whether the connection has been previously utilized. In response to user selection of a candidate connection that has not been previously utilized, a single screen may be caused to be displayed in order to solicit user input relating to one or more credentials that are required to be utilized in a candidate connection.

In a further embodiment, an apparatus is provided that includes means for identifying a plurality of candidate connections to a wide area network and means for causing a common display of a candidate connection. The means for causing the common display of candidate connections may include means for separating the candidate connections into at least two groups, with a first group including any candidate connection that is configured to be automatically established, and a second group including any candidate connection that is not configured to be automatically established. The apparatus of this embodiment may also include means for switching a respective candidate connection between the first and second groups based upon user input directing that the respective candidate connection be included in a different group so that the manner of establishing the respective candidate connection is correspondingly altered.

In one embodiment, the means for separating the candidate connections into at least two groups may include means for placing each candidate connection that has been previously utilized and that is configured to be automatically established in the first group. The means for separating the candidate connections into at least two groups of this embodiment may also include the means for placing each candidate connection that has been previously established and that is not configured to be automatically established as well as each candidate connection that is available but that has not been previously utilized in the second group. In addition, the means for identifying the plurality of candidate connections may include means for receiving an identification of each candidate connection identified in a scan and means for identifying, for each candidate connection, whether the respective candidate connection has been previously utilized and, in an instance in which the respective candidate connection has been previously utilized, whether the respective candidate connection is configured to be automatically established.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a schematic representation of a system in accordance with one embodiment of the present invention;

FIG. 2 is a block diagram of a terminal apparatus in accordance with one embodiment of the present disclosure;

FIG. 3 is a flow chart of the operations performed in accordance with one embodiment of the present invention;

FIG. 4 is a representation of a user interface presented in accordance with one embodiment of the present invention; and

FIG. 5 depicts three user interfaces that are presented in accordance with one embodiment of the present invention, in order to solicit configuration and/or security information.

### DETAILED DESCRIPTION

Embodiments of the present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

As used herein, the term “circuitry” refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

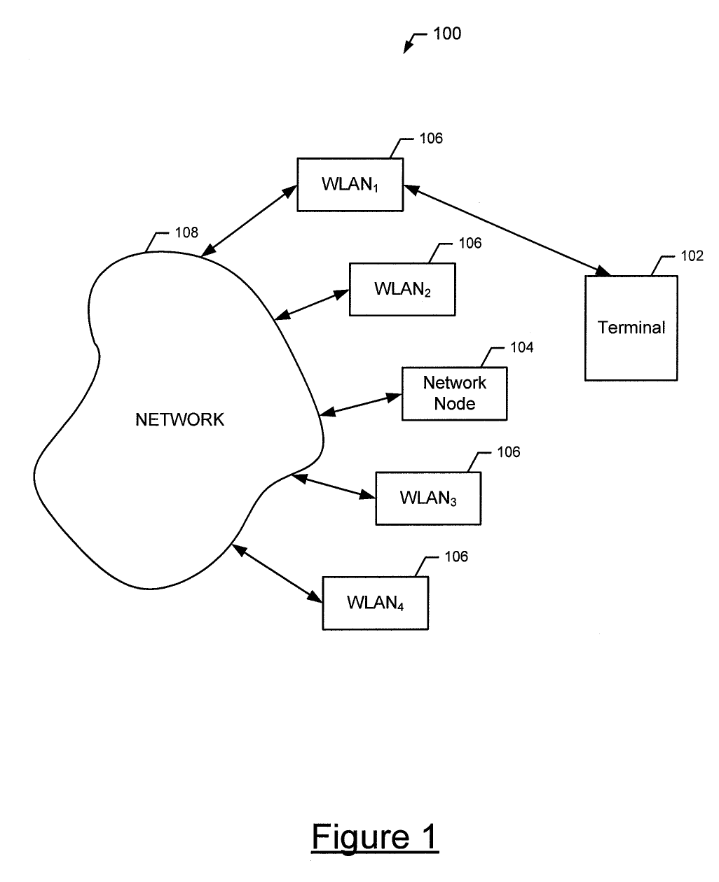

FIG. 1 illustrates a block diagram of a system 100 that provides several different candidates via which a terminal apparatus 102 may connect with a network 108 according to an exemplary embodiment of the present invention. As used herein, “exemplary” merely means an example and as such represents one example embodiment for the invention and should not be construed to narrow the scope or spirit of the invention in any way. It will be appreciated that the scope of the invention encompasses many potential embodiments in addition to those illustrated and described herein. As such, while FIG. 1 illustrates one example of a configuration of a system that provides multiple candidates via which a terminal apparatus may establish connections with the network, numerous other configurations may also be used to implement embodiments of the present invention.

In at least some embodiments, the system 100 includes one or more terminal apparatus 102, one or more network nodes 104, and a network 108. The network 108 may comprise one or more wireline networks, one or more wireless networks, or some combination thereof. In one embodiment, the network 108 comprises the Internet, although the network may be an intranet or any wide area network including, for example, a public land mobile network (e.g., a cellular network), such as may be implemented by a network operator (e.g. a cellular access provider). The network 108 may operate in accordance with universal terrestrial radio access network (UTRAN) standards, evolved UTRAN (E-UTRAN) standards, GSM (Global System for Mobile communications) EDGE (Enhanced Data GSM Environment) radio access network (GERAN) standards and/or the like. It will be appreciated, however, that where references herein are made to a network standard and/or terminology particular to a network standard, the references are provided merely by way of example and not by way of limitation.

The terminal apparatus 102 is configured to connect to and communicate with the network 108 via any one of a plurality of candidate connections. In this regard, the embodiment of FIG. 1 includes a plurality of wireless local area networks (WLANs) 106 that permit the terminal apparatus to establish connections and communicate with the network. Additionally, the system 100 may include one or more network nodes 104 that also permit connection to and communication with the network, such as for packet data transmission, e.g., GPRS (General Packet Radio Service) packet data. In this regard, the network node may comprise a network entity configured to support communications between a terminal apparatus and the network, such as for packet data transmission or the like. In this regard, the network node may comprise, for example, a base station that is configured to provide access to the network for the terminal apparatus.

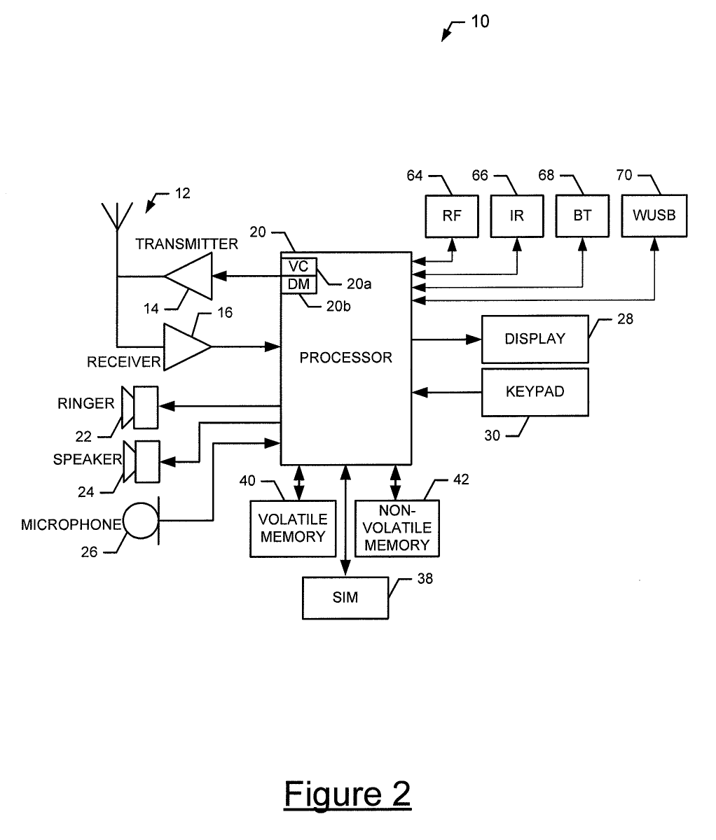

The terminal apparatus 102 may be embodied as user equipment (UE), such as a desktop computer, laptop computer, mobile terminal, mobile computer, mobile phone, mobile communication device, game device, digital camera/camcorder, audio/video player, television device, radio receiver, digital video recorder, positioning device, any combination thereof, and/or the like. In an exemplary embodiment, the terminal apparatus 102 is embodied as a mobile terminal, such as that illustrated in FIG. 2.

In this regard, FIG. 2 illustrates a block diagram of a mobile terminal 10 representative of one embodiment of a terminal apparatus 102 in accordance with embodiments of the present invention. It should be understood, however, that the mobile terminal 10 illustrated and hereinafter described is merely illustrative of one type of terminal apparatus 102 that may implement and/or benefit from embodiments of the present invention and, therefore, should not be taken to limit the scope of the present invention. While several embodiments of the electronic device are illustrated and will be hereinafter described for purposes of example, other types of electronic devices, such as mobile telephones, mobile computers, portable digital assistants (PDAs), pagers, laptop computers, desktop computers, gaming devices, televisions, and other types of electronic systems, may employ embodiments of the present invention.

As shown, the mobile terminal 10 may include an antenna 12 (or multiple antennas 12) in communication with a transmitter 14 and a receiver 16. The mobile terminal 10 may also include a processor 20 configured to provide signals to and receive signals from the transmitter and receiver, respectively. The processor 20 may, for example, be embodied as various means including circuitry, one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an ASIC (application specific integrated circuit) or FPGA (field programmable gate array), or some combination thereof. Accordingly, although illustrated in FIG. 2 as a single processor, in some embodiments the processor 20 comprises a plurality of processors. The signals sent and received by the processor 20 may include signaling information in accordance with an air interface standard of an applicable cellular system, and/or any number of different wireline or wireless networking techniques, comprising but not limited to Wireless-Fidelity (Wi-Fi), WLAN techniques such as Institute of Electrical and Electronics Engineers (IEEE) 802.11, 802.16, and/or the like. In addition, these signals may include speech data, user generated data, user requested data, and/or the like. In this regard, the mobile terminal may be capable of operating with one or more air interface standards, communication protocols, modulation types, access types, and/or the like. More particularly, the mobile terminal may be capable of operating in accordance with various first generation (1G), second generation (2G), 2.5G, third-generation (3G) communication protocols, fourth-generation (4G) communication protocols, Internet Protocol Multimedia Subsystem (IMS) communication protocols (e.g., session initiation protocol (SIP)), and/or the like. For example, the mobile terminal may be capable of operating in accordance with 2G wireless communication protocols IS-136 (Time Division Multiple Access (TDMA)), Global System for Mobile communications (GSM), IS-95 (Code Division Multiple Access (CDMA)), and/or the like. Also, for example, the mobile terminal may be capable of operating in accordance with 2.5G wireless communication protocols GPRS, Enhanced Data GSM Environment (EDGE), and/or the like. Further, for example, the mobile terminal may be capable of operating in accordance with 3G wireless communication protocols such as Universal Mobile Telecommunications System (UMTS), Code Division Multiple Access 2000 (CDMA2000), Wideband Code Division Multiple Access (WCDMA), Time Division-Synchronous Code Division Multiple Access (TD-SCDMA), and/or the like. The mobile terminal may be additionally capable of operating in accordance with 3.9G wireless communication protocols such as Long Term Evolution (LTE) or E-UTRAN and/or the like. Additionally, for example, the mobile terminal may be capable of operating in accordance with fourth-generation (4G) wireless communication protocols and/or the like as well as similar wireless communication protocols that may be developed in the future.

Some Narrow-band Advanced Mobile Phone System (NAMPS), as well as Total Access Communication System (TACS), mobile terminals may also benefit from embodiments of this invention, as should dual or higher mode phones (e.g., digital/analog or TDMA/CDMA/analog phones). Additionally, the mobile terminal 10 may be capable of operating according to Wireless Fidelity (Wi-Fi) or Worldwide Interoperability for Microwave Access (WiMAX) protocols.

It is understood that the processor 20 may comprise circuitry for implementing audio/video and logic functions of the mobile terminal 10. For example, the processor 20 may comprise a digital signal processor device, a microprocessor device, an analog-to-digital converter, a digital-to-analog converter, and/or the like. Control and signal processing functions of the mobile terminal may be allocated between these devices according to their respective capabilities. The processor may additionally comprise an internal voice coder (VC) 20a, an internal data modem (DM) 20b, and/or the like. Further, the processor may comprise functionality to operate one or more software programs, which may be stored in memory. For example, the processor 20 may be capable of operating a connectivity program, such as a web browser. The connectivity program may allow the mobile terminal 10 to transmit and receive web content, such as location-based content, according to a protocol, such as Wireless Application Protocol (WAP), hypertext transfer protocol (HTTP), and/or the like. The mobile terminal 10 may be capable of using a Transmission Control Protocol/Internet Protocol (TCP/IP) to transmit and receive web content across the internet or other networks.

The mobile terminal 10 may also comprise a user interface including, for example, an earphone or speaker 24, a ringer 22, a microphone 26, a display 28, a user input interface, and/or the like, which may be operationally coupled to the processor 20. In this regard, the processor 20 may comprise user interface circuitry configured to control at least some functions of one or more elements of the user interface, such as, for example, the speaker 24, the ringer 22, the microphone 26, the display 28, and/or the like. The processor 20 and/or user interface circuitry comprising the processor 20 may be configured to control one or more functions of one or more elements of the user interface through computer program instructions (e.g., software and/or firmware) stored on a memory accessible to the processor 20 (e.g., volatile memory 40, non-volatile memory 42, and/or the like). Although not shown, the mobile terminal may comprise a battery for powering various circuits related to the mobile terminal, for example, a circuit to provide mechanical vibration as a detectable output. The user input interface may comprise devices allowing the mobile terminal to receive data, such as a keypad 30, a touch display (not shown), a joystick (not shown), and/or other input device. In embodiments including a keypad, the keypad may comprise numeric (0-9) and related keys (#, *), and/or other keys for operating the mobile terminal.

The mobile terminal 10 may comprise memory, such as one or more subscriber identity modules (SIMs) 38, universal SIMs (USIMs), removable user identity modules (R-UIMs), and/or the like, which may store information elements related to a mobile subscriber. In addition to the SIM, the mobile terminal may comprise other removable and/or fixed memory. The mobile terminal 10 may include volatile memory 40 and/or non-volatile memory 42. For example, volatile memory 40 may include Random Access Memory (RAM) including dynamic and/or static RAM, on-chip or off-chip cache memory, and/or the like. Non-volatile memory 42, which may be embedded and/or removable, may include, for example, read-only memory, flash memory, magnetic storage devices (e.g., hard disks, floppy disk drives, magnetic tape, etc.), optical disc drives and/or media, non-volatile random access memory (NVRAM), and/or the like. Like volatile memory 40, non-volatile memory 42 may include a cache area for temporary storage of data. The memories may store one or more software programs, instructions, pieces of information, data, and/or the like which may be used by the mobile terminal for performing functions of the mobile terminal. For example, the memories may store instructions which, when executed by the processor, cause the processor to perform the functions described herein. The memories may also comprise an identifier, such as an international mobile equipment identification (IMEI) code, capable of uniquely identifying the mobile terminal 10.

As shown in FIG. 2, the mobile terminal 10 may also include one or more means for sharing and/or obtaining data. For example, the mobile terminal may comprise a short-range radio frequency (RF) transceiver and/or interrogator 64 so data may be shared with and/or obtained from electronic devices in accordance with RF techniques. The mobile terminal may comprise other short-range transceivers, such as, for example, an infrared (IR) transceiver 66, a Bluetooth™ (BT) transceiver 68 operating using Bluetooth™ brand wireless technology developed by the Bluetooth™ Special Interest Group, a wireless universal serial bus (USB) transceiver 70 and/or the like. The Bluetooth™ transceiver 68 may be capable of operating according to ultra-low power Bluetooth™ technology (e.g., Wibree™) radio standards. In this regard, the mobile terminal 10 and, in particular, the short-range transceiver may be capable of transmitting data to and/or receiving data from electronic devices within a proximity of the mobile terminal, such as within 10 meters, for example. Although not shown, the mobile terminal may be capable of transmitting and/or receiving data from electronic devices according to various wireless networking techniques, including Wireless Fidelity (Wi-Fi), WLAN techniques such as IEEE 802.11 techniques, IEEE 802.15 techniques, IEEE 802.16 techniques, and/or the like.

As shown in FIG. 1, the terminal apparatus 102 may communicate with the network 108 via a number of different candidate connections, including both WLANs 106 and network nodes 104. In accordance with one embodiment of the present invention, a method and apparatus are provided to present the user of the terminal apparatus with information regarding the candidate connections such that the user is apprised of the candidate connection that may be utilized and to permit the user with an opportunity to alter the connection that will be utilized if the user wishes to establish communications with the network via a different connection.

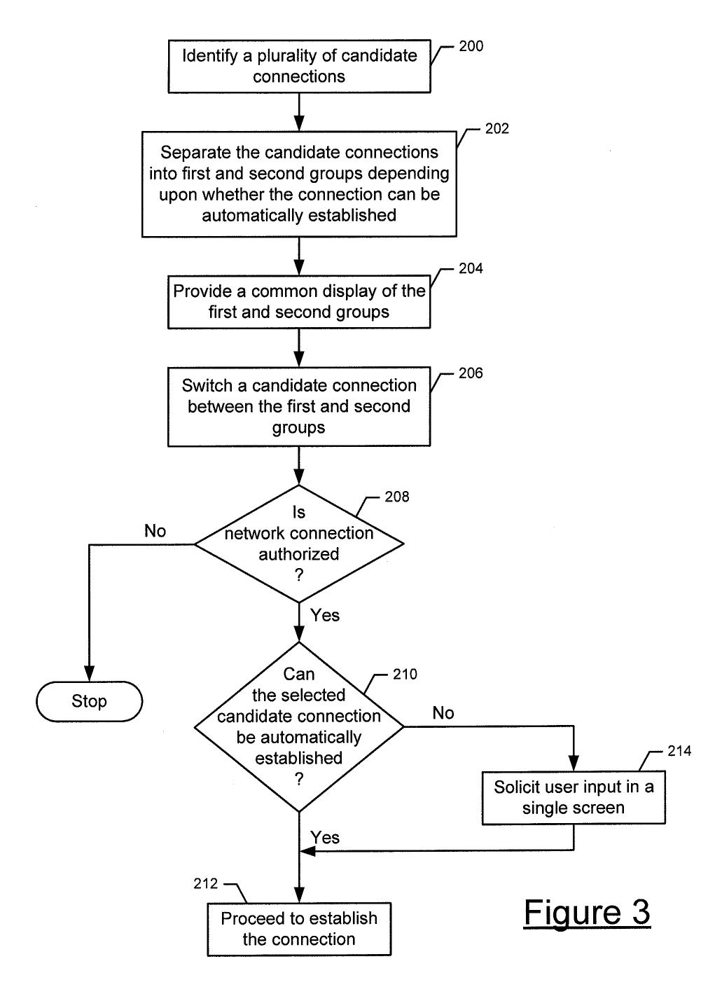

As illustrated in operation 200 of FIG. 3, the terminal apparatus 102 includes means, such as the processor 20, the receiver 16, the antenna 12, the RF transceiver and/or interrogator 64, the IR transceiver 66, the BT transceiver 68 and/or the WUSB transceiver 70, for identifying a plurality of candidate connections to the network 108. In the illustrated embodiment, for example, the processor may receive input from the antenna and the receiver indicating that the network node 104 is a candidate for establishing a connection, such as a GPRS packet data connection, with the network. In addition, the processor of the illustrated embodiment may receive input from the RF transceiver and/or interrogator, IR transceiver, BT transceiver and/or WUSB transceiver that indicates that four WLANs, e.g., WLAN₁, WLAN₂, WLAN₃ and WLAN₄, are available and are candidates with respect to establishing a connection with the network. It should be understood, however, that that embodiment depicted in FIG. 1 is merely an example with the method and apparatus capable of identifying other combinations of candidate connections with the network in other embodiments.

In order to identify the candidate connections, the terminal apparatus 102 may include means, such as the processor 20, the receiver 16, the antenna 12, the RF transceiver and/or interrogator 64, the IR transceiver 66, the BT transceiver 68 and/or the WUSB transceiver 70, for conducting a scan of, and receiving an identification of each candidate connection, that is in communication with the terminal apparatus. The terminal apparatus of this embodiment may also include means, such as the processor, for identifying, for each candidate connection, whether the respective candidate connection has been previously utilized and, in an instance in which the respective candidate connection has been previously utilized, whether the respective candidate connection is configured to be automatically established. In this regard, the processor may access records stored by memory, e.g., volatile memory 40 or non-volatile memory 42, that identify the connections that have been previously utilized by the terminal apparatus to communicate with the network 108, as well as information that identifies whether each such connection is configured to be automatically established or requires manual or other input.

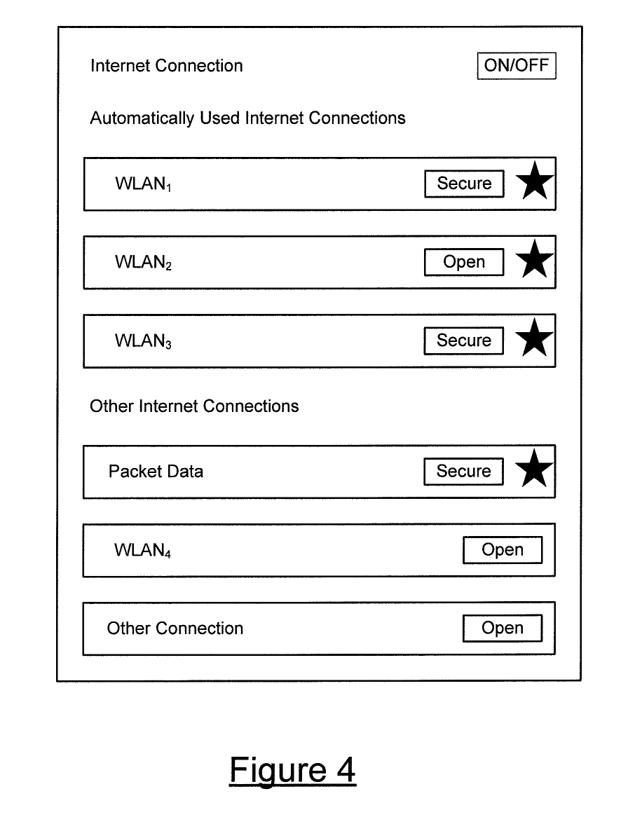

Based upon the identification of the candidate connections, the terminal apparatus 102 may include means, such as the processor 20, the display 28 or the like, for causing a common display of the candidate connections. See operation 204 of FIG. 3. In this regard, the processor may be configured to instruct the display to present a user interface that includes an identification of each of the candidate connections. As shown in FIG. 4, for example, the user interface may identify the type of connection, such as a WLAN connection, a packet data connection or another connection. For example, the user interface may identify the type of connection, either alphanumerically, with an icon or both. Although each of the candidate connections is displayed in a common display, the apparatus may include means, such as the processor, for separating the candidate connections into at least two groups prior to the common display. See operation 202 of FIG. 3. As shown in FIG. 4, for example, the first group may include any candidate connection that is configured to be automatically established. In the illustrated embodiment, three WLANs, e.g., WLAN₁, WLAN₂ and WLAN₃, are identified to be candidate connections to which the terminal apparatus may automatically connect. In this regard, the candidate connections that may be automatically established have generally been utilized previously by the terminal apparatus in order to communicate with the network 108 and, as such, any credentials, settings or other security information that would otherwise need to be provided by the user of the terminal apparatus have already been provided and stored.

In addition to the first group that includes any candidate connection that is configured to be automatically established, the common display may include a second group having any candidate connection that is not configured to be automatically established. For example, the user interface of FIG. 3 includes three different candidate connections in the second group that are not configured to be automatically established. These candidate connections include a packet data connection, such as supported by the network node 104, another WLAN connection, e.g., WLAN₄, and another connection. The candidate connections that are included in the second group may include candidate connections that have been previously utilized to establish to support communications between the terminal apparatus 102 and the network 108, but that are not configured to be automatically established and which, instead, require manual input to effect the connection. Additionally, the second group may include each candidate connection that is identified to be available, but that has not been previously utilized. For example, the “other connection” in the second group of the user interface of FIG. 3 may have been newly identified and may require user input, such as in terms of credentials, selections or other security information prior to permitting establishment of a connection with the network. Once such a newly identified candidate connection has been utilized, such as following user input of any necessary information, the newly identified candidate connection may, in some embodiments, thereafter be identified as a candidate connection that may be automatically established if no additional user input is required for subsequent utilization of the candidate connection. In one example embodiment, the newly identified candidate connection may be a hidden WLAN or another type of hidden connection that does not broadcast its presence, but must, instead, be proactively engaged by the terminal apparatus.

The user interface provided by the display 28 may also provide additional information regarding at least some of the candidate connections. For example, the user interface may include an icon or other representation that provides information as to the security status of the candidate connection, such as whether the candidate connection is a secured connection or is an open or unsecured connection. In addition, the user interface may include an icon or other representation indicating whether a candidate connection has been previously utilized by the terminal apparatus 102 in order to establish communications with the network 108. In this regard, each candidate connection that has been previously utilized is associated with a star in the example embodiment of FIG. 3. As shown in the illustrated embodiment, each of the WLANs that are configured to support an automatically established connection has been previously utilized. However, the packet data connection that is not configured to be automatically established has also been utilized previously, but still requires manual input prior to establishing the packet data connection.

In one embodiment, the candidate connections are ordered in a prioritized manner such that the terminal apparatus 102 will initially attempt to establish communications with the network 108 via the first-listed candidate connection. If the terminal apparatus is successful in establishing communications with the network via the first listed candidate connection, the terminal apparatus of one embodiment will not thereafter attempt to establish communications with the network with any of the other candidate connections so long as the connection that has been established remains operational. If, however, the terminal apparatus is unable to establish a connection with the network via the first-listed candidate connection, the terminal apparatus may thereafter attempt to establish a connection with the network via the second-listed candidate connection. The terminal apparatus may continue this process of sequentially attempting to establish communications with the network via each of the candidate connections in order until a successful connection has been established, at which point further efforts to establish another communication connection with the network are discontinued.

Thus, the terminal apparatus 102 of one embodiment may include means, such as the processor 20, the display 28 or the like, for permitting a user to reorder the communication connections. See operation 206 of FIG. 3. In one embodiment, for example, the display upon which the user interface is presented may be touch-sensitive. Thus, the user may select one of the candidate connections by touching the respective candidate connections and may then switch the order of the candidate connections by dragging the candidate connection to another location in the listing. The candidate connection that has been moved by the user may then appear in an updated listing of the candidate connections in the new location that has been selected by the user so as to effectively reorganize the prioritization of the candidate connections. By way of example, one user may prefer to utilize WLAN connections prior to packet data connections, such as shown in FIG. 4. Alternatively, another user may prefer to utilize a packet data connection prior to utilizing a WLAN connection. As such, this other user may re-prioritize the candidate connection such that the packet data connection is the first listed candidate connection.

In operation, the user of the terminal apparatus 102 may initially provide input authorizing a network connection, such as an internet connection. See operation of 208 of FIG. 3. In this regard, the user interface may include a toggle button or other type of input via which the user can provide an indication that the establishment of a network connection, such as an Internet connection, is permitted. Thereafter, the terminal apparatus may identify the candidate connections, such as by conducting a scan of candidate connections. See operation 200 of FIG. 3. The terminal apparatus may then present a common display of the candidate connections with the candidate connections appropriately separated, such as shown in operations 202 and 204 of FIG. 3 as well as in the user interface of FIG. 4. Unless the user of the terminal apparatus reorders the candidate connections as shown in operation 206 of FIG. 3 or selects one of the candidate connections, such as by double-clicking on a respective candidate connection, the terminal apparatus, such as the processor 20, of one embodiment will then attempt to establish a connection with the first-listed candidate connection and will only proceed to attempt to establish a connection with any of the other candidate connections if the efforts to establish a connection with the first-listed candidate connection are unsuccessful as described above.

The method and apparatus of one embodiment may also be configured to facilitate user entry of various settings, credentials or the like that may be required, in some instances, prior to communication via a respective connection with the network. For example, a candidate connection that has been identified for the first time may require the user to provide information, such as credentials or other security information, prior to supporting a connection between the terminal apparatus 102 and the network 108. Additionally, some of the candidate connections that do not permit automatic establishment of the connections may require user input of credentials or other security information each time prior to the establishment of a connection with the network. Unlike a dialog wizard that may require multiple displays to solicit the necessary information from a user, however, the method and apparatus of one embodiment may include means, such as the processor 20, for causing a display of a single screen that is configured to solicit user input relating to one or more credentials that may be required to utilize a candidate connection, such as in response to a user input selection of a candidate connection that has not been previously utilized.

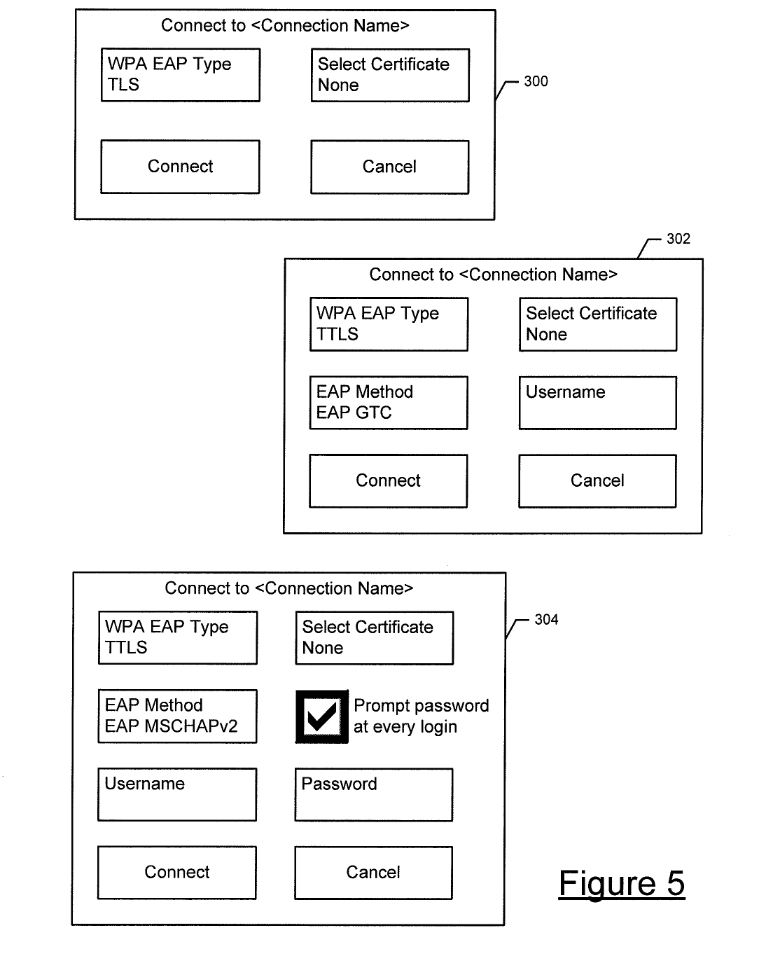

As shown in FIG. 5, the displays presented in conjunction with three different candidate connections are shown for purposes for example, but not of limitation. In a first display, a candidate connection requires the user to input the Wi-Fi Protected Access (WPA) Extensible Authentication Protocol (EAP) and to select the certificate, if any. In a second embodiment, the user selection of a WPA EAP of Transport Layer Security (TLS) further requires the user to identify the EAP method, such as EAP Generic Token Control (GTC), and to enter a user name. Still further, the user identification of a WPA EAP type of Tunneled Transport Layer Security (TTLS) and an EAP method of EAP Microsoft Challenge Handshake Authentication Protocol (MSCHAPv2) causes the presentation of a display screen that solicits both the user name and a password prior to permitting connection. By soliciting all of the user input that is required in order to establish a connection in a single screen, a user may efficiently enter the information in a manner that is straightforward and does not cause confusion. Thus, the method and apparatus of this embodiment also facilitates the user input of the information that is required in order to establish a connection, thereby further facilitating the network connectivity of a terminal apparatus 102. Thus, as shown in operations 210-214 of FIG. 3, a connection may be immediately established with a selected candidate connection, e.g., the first-listed candidate connection or other candidate connection that has been selected, that is capable of being automatically established, while user input may be first solicited prior to establishing the connection when the selected candidate connection is not capable of being automatically established.

As described above, FIG. 3 is a flowchart of an apparatus, method, and computer program product according to exemplary embodiments of the invention. It will be understood that each block of the flowchart, and combinations of blocks in the flowchart, may be implemented by various means, such as hardware and/or a computer program product comprising one or more computer-readable mediums having computer readable program instructions stored thereon. For example, one or more of the procedures described herein may be embodied by computer program instructions of a computer program product. In this regard, the computer program product which embodies the procedures described herein as being performed by the terminal apparatus 102 may be stored by one or more memory devices 40, 42 of the terminal apparatus and executed by the processor 20 of the terminal apparatus. In some embodiments, the computer program instructions comprising the computer program product(s) which embody the procedures described above may be stored by memory devices of a plurality of computing devices, such as the network node and the terminal apparatus. As will be appreciated, any such computer program product may be loaded onto a computer or other programmable apparatus to produce a machine, such that the computer program product including the instructions which execute on the computer or other programmable apparatus creates means for implementing the functions specified in the flowchart block(s). Further, the computer program product may comprise one or more computer-readable memories on which the computer program instructions may be stored such that the one or more computer-readable memories can direct a computer or other programmable apparatus to function in a particular manner, such that the computer program product comprises an article of manufacture which implements the function specified in the flowchart block(s). The computer program instructions of one or more computer program products may also be loaded onto a computer or other programmable apparatus (e.g., a terminal apparatus 102) to cause a series of operations to be performed on the computer or other programmable apparatus to produce a computer-implemented process such that the instructions which execute on the computer or other programmable apparatus implement the functions specified in the flowchart block(s).

Accordingly, blocks of the flowchart support combinations of means for performing the specified functions for performing the specified functions. It will also be understood that one or more blocks of the flowchart, and combinations of blocks in the flowchart, may be implemented by special purpose hardware-based computer systems which perform the specified functions or combinations of special purpose hardware and computer program product(s).

The above described functions may be carried out in many ways. For example, any suitable means for carrying out each of the functions described above may be employed to carry out embodiments of the invention. In one embodiment, a suitably configured processor 20 of the terminal apparatus 102 may provide means for performing the respective functions, as shown in FIG. 3 and described above. In another embodiment, all or a portion of the elements of the invention may be configured by and operate under control of a computer program product. The computer program product for performing the methods of embodiments of the invention includes a computer-readable storage medium, such as the non-volatile storage medium, and computer-readable program code portions, such as a series of computer instructions, embodied in the computer-readable storage medium.

Many modifications and other embodiments of the inventions set forth herein will come to mind to one skilled in the art to which these embodiments pertain having the benefit of the teachings presented in the foregoing description and the associated drawings. Therefore, it is to be understood that the invention is not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions other than those explicitly described above are also contemplated as may be set forth in some of the appended claims. Although specific terms are employed herein, they are used in a generic and descriptive sense only and not for purposes of limitation.

That which is claimed:

1. A method comprising:
identifying a plurality of candidate connections to a wide area network;
causing a common display of the candidate connections, wherein causing the common display comprises separating the candidate connections into at least two groups with a first group including any candidate connection that is configured to be automatically established and a second group including any candidate connection that is not configured to be automatically established; and
switching a respective candidate connection between the first and second groups based upon user input directing that the respective candidate connection be included in a different group so that a manner of establishing the respective candidate connection is correspondingly altered.

2. A method according to claim 1 wherein separating the candidate connections into at least two groups comprises placing: (i) each candidate connection that has been previously utilized and that is configured to be automatically established in the first group, and (ii) each candidate connection that has been previously utilized and that is not configured to be automatically established and each candidate connection that is available but has not been previously utilized in the second group.

3. A method according to claim 2 wherein identifying the plurality of candidate connections comprises receiving an identification of each candidate connection identified in a scan and identifying, for each candidate connection, whether the respective candidate connection has been previously utilized and, in an instance in which the respective candidate connection has been previously utilized, whether the respective candidate connection is configured to be automatically established.

4. A method according to claim 1 wherein switching the respective candidate connection comprises at least one of receiving user input directing that a candidate connection in the first group be moved to the second group such that the respective candidate connection is then configured to be manually established or receiving user input directing that a candidate connection in the second group be moved to the first group such that the respective candidate connection is then configured to be automatically established.

5. A method according to claim 1 wherein causing a common display comprises associating one or more icons with a candidate connection indicating at least one of a type of connection, whether the connection is secured or whether the connection has been previously utilized.

6. A method according to claim 1 further comprising causing a display of a single screen, in response to user input selection of a candidate connection that has not been previously utilized, that is configured to solicit user input relating to one or more credentials that are required to utilize the candidate connection.

7. An apparatus comprising at least one processor and at least one memory including computer program code, the at least one memory and the computer program code configured to, with the processor, cause the apparatus to at least perform:
identifying a plurality of candidate connections to a wide area network;
causing a common display of the candidate connections, wherein causing the common display comprises separating the candidate connections into at least two groups with a first group including any candidate connection that is configured to be automatically established and a second group including any candidate connection that is not configured to be automatically established; and
switching a respective candidate connection between the first and second groups based upon user input directing that a respective candidate connection be included in a different group so that a manner of establishing the respective candidate connection is correspondingly altered.

8. An apparatus according to claim 7 wherein separating the candidate connections into at least two groups comprises placing: (i) each candidate connection that has been previously utilized and that is configured to be automatically established in the first group, and (ii) each candidate connection that has been previously utilized and that is not configured to be automatically established and each candidate connection that is available but has not been previously utilized in the second group.

9. An apparatus according to claim 8 wherein identifying the plurality of candidate connections comprises receiving an identification of each candidate connection identified in a scan and identifying, for each candidate connection, whether the respective candidate connection has been previously utilized and, in an instance in which the respective candidate connection has been previously utilized, whether the respective candidate connection is configured to be automatically established.

10. An apparatus according to claim 7 wherein switching the respective candidate connection comprises at least one of receiving user input directing that a candidate connection in the first group be moved to the second group such that the respective candidate connection is then configured to be manually established or receiving user input directing that a candidate connection in the second group be moved to the first group such that the respective candidate connection is then configured to be automatically established.

11. An apparatus according to claim 7 wherein causing a common display comprises associating one or more icons with a candidate connection indicating at least one of a type of connection, whether the connection is secured or whether the connection has been previously utilized.

12. An apparatus according to claim 7 wherein the at least one memory and the computer program code are further configured to, with the processor, cause the apparatus to cause a display of a single screen, in response to user input selection of a candidate connection that has not been previously utilized, that is configured to solicit user input relating to one or more credentials that are required to utilize the candidate connection.

13. A computer program product comprising at least one computer-readable storage medium having computer-executable program code portions stored therein, the computer-executable program code portions comprising:
program code instructions for identifying a plurality of candidate connections to a wide area network;
program code instructions for causing a common display of the candidate connections, wherein the program code instructions for causing the common display comprise program code instructions for separating the candidate connections into at least two groups with a first group including any candidate connection that is configured to be automatically established and a second group including any candidate connection that is not configured to be automatically established; and
program code instructions for switching a respective candidate connection between the first and second groups based upon user input directing that a respective candidate connection be included in a different group so that a manner of establishing the respective candidate connection is correspondingly altered.

14. A computer program product according to claim 13 wherein the program code instructions for separating the candidate connections into at least two groups comprise program code instructions for placing: (i) each candidate connection that has been previously utilized and that is configured to be automatically established in the first group, and (ii) each candidate connection that has been previously utilized and that is not configured to be automatically established and each candidate connection that is available but has not been previously utilized in the second group.

15. A computer program product according to claim 14 wherein the program code instructions for identifying the plurality of candidate connections comprise program code instructions for receiving an identification of each candidate connection identified in a scan and identifying, for each candidate connection, whether the respective candidate connection has been previously utilized and, in an instance in which the respective candidate connection has been previously utilized, whether the respective candidate connection is configured to be automatically established.

16. A computer program product according to claim 13 wherein the program code instructions for switching a respective candidate connection comprise program code instructions for at least one of receiving user input directing that a candidate connection in the first group be moved to the second group such that the respective candidate connection is then configured to be manually established or receiving user input directing that a candidate connection in the second group be moved to the first group such that the respective candidate connection is then configured to be automatically established.

17. A computer program product according to claim 13 wherein the program code instructions for causing a common display comprises program code instructions for associating one or more icons with a candidate connection indicating at least one of a type of connection, whether the connection is secured or whether the connection has been previously utilized.

18. A computer program product according to claim 13 further comprising program code instructions for causing a display of a single screen, in response to user input selection of a candidate connection that has not been previously utilized, that is configured to solicit user input relating to one or more credentials that are required to utilize the candidate connection.

19. An apparatus comprising:
means for identifying a plurality of candidate connections to a wide area network;
means for causing a common display of the candidate connections, wherein the means for causing the common display comprises means for separating the candidate connections into at least two groups with a first group including any candidate connection that is configured to be automatically established and a second group including any candidate connection that is not configured to be automatically established; and
means for switching a respective candidate connection between the first and second groups based upon user input directing that the respective candidate connection be included in a different group so that a manner of establishing the respective candidate connection is correspondingly altered.

20. An apparatus according to claim 19 wherein the means for separating the candidate connections into at least two groups comprises means for placing: (i) each candidate connection that has been previously utilized and that is configured to be automatically established in the first group, and (ii) each candidate connection that has been previously utilized and that is not configured to be automatically established and each candidate connection that is available but has not been previously utilized in the second group, and wherein the means for identifying the plurality of candidate connections comprises means for receiving an identification of each candidate connection identified in a scan and means for identifying, for each candidate connection, whether the respective candidate connection has been previously utilized and, in an instance in which the respective candidate connection has been previously utilized, whether the respective candidate connection is configured to be automatically established.
